(19) United States
(12) Patent Application Publication
(10) Pub. No.: US 2006/0103953 A1
(43) Pub. Date: May 18, 2006

(54) Electrical micro-optic module with improved joint structures

(75) Inventors: James Lee, Taipei (TW); Chung-I Chiang, Taipei (TW)

Correspondence Address: LADAS & PARRY, 26 WEST 61ST STREET, NEW YORK, NY, 10023, US

(73) Assignee: NSMC HOLDINGS INTERNATIONAL CORP. LTD.

(21) Appl. No.: 10/989,156

(22) Filed: Nov. 15, 2004

(51) Int. Cl. G02B 7/02

(52) U.S. Cl. 359/819

(57) ABSTRACT

An electrical micro-optic module (eMOM) includes a structure having zigzag contact surfaces and variable thread pitches. The structure elongates the path of contaminated particles and effectively reduces the amount of contamination to almost one order of magnitude due to the exponential decay of contamination versus path. Moreover, an electrostatic discharge (ESD) protection ring and conductive painting are used for static charge removal.

### BACKGROUND OF THE INVENTION

(A) Field of the Invention

The present invention relates generally to an electrical micro-optic module (eMOM) with an improved joint structure. Specifically, the present invention relates to the joint structure within a compact camera module (CCM.)

(B) Description of Related Art

There has been a constant demand for an electrical micro-optic module (eMOM) with small “footprint”(area occupied by a device), low height and nevertheless high endurance, which module is mounted into a portable consumer electronic product, such as a compact camera module (CCM) for a mobile phone. A typical structure of the eMOM includes optical parts (such as lens head) and electrical devices (such as image sensor) precisely packaged together. Generally, performance degradation results from poor conditions of dust particles (either absorbed or moveable) as well as moisture, electromagnetic interference, vibration, mechanical impact and light leakage. Usually, the smaller the module, the more sensitive it is with respect to these influences.

U.S. Pat. No. 6,667,543, by Wai Wong Chow et. al., uses mold compound to support the optics above a sensor and uses cover glass to prevent particles generated during the packaging process from falling directly on the sensor. However, particles still exist and are harmful to the image quality.

U.S. Pat. No. 6,734,419, by Thomas P. Glenn, et. al., uses a lead frame for supporting a molded image sensor die package. However, it gives no evidence of possible particle prevention and hermetic sealing so that it cannot solve the above-mentioned problems.

The present invention provides various designs for sealing of a joint structure within an electrical micro-optic module, which module provides greater resistance to dust particles as well as moisture, electromagnetic interference, vibration, mechanical impact and light leakage.

### SUMMARY OF THE INVENTION

The present invention relates to a joint structure within an electrical micro-optic module, which provides greater resistance to dust particles as well as moisture, electromagnetic interference, vibration, mechanical impact and light leakage. The innovated part of the joint structure includes a “zigzag” design, which elongates the length of joint interface so that particles or moisture perorated from outside will be reduced. The zigzag design also provides greater isolation to light. Additional particle collection grooves can be formed in a pattern of more than one concentric circle on the contact surface of the lens mount so as to collect particles once they fall.

For better protection, thread structures of lens barrel and lens mount can be modified into a tapered thread. The thread pitch is reduced gradually from outermost side (Object side) to the innermost side (Image side). Reducing the pitch provides thread coupling and self-lock effect as well as better isolation to particles, moisture and light.

The protection can also be modified according to the concept of “defense in layers”, meaning that more than one protecting structure will be listed from outer side to inner side for greater isolation. This can be achieved by an “outer thread collar” design. An additional collar structure is located outside the lens mount, and all threading interfaces are moved to the collar so that particles generated during threading will drop mostly outside the area of light path.

In some particular applications, such as lower resolution optical lens for toy or webcam, the focus need not be fine adjusted, so that people can simply “seal” (or “remove”) the zigzag interface and threading structures and thus the lens barrel and lens mount will be combined into one piece. Although the focus cannot be adjusted in this design, the isolation effect will be the best because no contact surfaces exist.

To improve the effect against ESD (electrostatic discharge) or EMI (electromagnetic interference), conductive paint can be applied on the outside surface of the lens barrel and lens mount so as to conduct static electricity into the substrate. An optional metal ring can be installed on the lens barrel for better protection of ESD by providing direct contact with the outer housing and shielding.

### BRIEF DESCRIPTION OF THE DRAWINGS

FIG. 1 is an enlarged, cross-section view of first embodiment illustrating the zigzag contact surface design in an eMOM in accordance with the present invention;

FIG. 2 is an enlarged, cross-section view of second embodiment illustrating the variable tapered thread pitch design with particle collection groove of an eMOM in accordance with the present invention.

FIG. 3 is an enlarged, cross-section view of third embodiment illustrating the outer thread lens mount design with collar of an eMOM in accordance with the present invention.

FIG. 4 is an enlarged, cross-section view of fourth embodiment illustrating the one piece compact lens set design of an eMOM in accordance with the present invention.

FIG. 5 is an enlarged, cross-section view of an embodiment illustrating the metal ring and conductive painting design of an eMOM in accordance with the present invention.

FIG. 6 is a 3-D schematic drawing of FIG. 5 showing an exemplary pattern of conductive painting according to the present invention.

### DETAILED DESCRIPTION OF THE INVENTION

The detailed description of the preferred embodiments with respect to the appended figures is intended to describe the present invention, and is not intended to limit forms to embody the present invention. It is understood that several embodiments can be practiced concurrently.

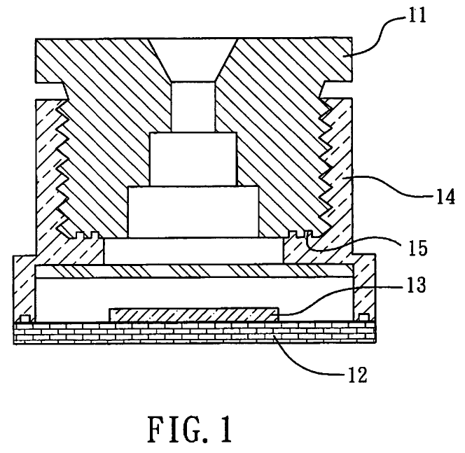

Referring to FIG. 1, the first embodiment of the present invention provides an electrical micro optics module with particle and moisture resistance through a zigzag interface design. The electrical micro optics module comprises: a substrate 12; an image sensor 13 located on the substrate 12; a lens barrel 11 in the shape of a cylinder, comprising an first circumferential surface, a first end surfaces, and a second end surface, wherein a first thread structure is formed on said first circumferential surface and a first zig-zag structure is formed on the second end surface; and a lens mount 14 covering the substrate 12, comprising a holding structure, of which inner walls are formed in an appropriate shape so as to install said lens barrel therein, and said appropriate shape comprising a second circumferential surface and an third surface, wherein a second thread structure is formed on said second circumferential surface and a second zig-zag structure is formed on the third end surface, whereby the first thread structure of the first circumferential surface is threaded into the second thread structure of the second circumferential surface, and after threading, the first zig-zag structure on the second end surface contacts and matches with the second zig-zag structure on the third end surface. The contact interface 15 between the first zigzag structure and the second zig-zag structure doubles the length of the particle and/or moisture penetrating path. Doubling the contamination path can effectively reduce the amount of contamination to almost one order of magnitude due to the exponential decay of the amount of contamination versus path follow simple Fick's diffusuion rules. Light blockage or opaqueness will be greatly improved due to absence of direct line of sight.

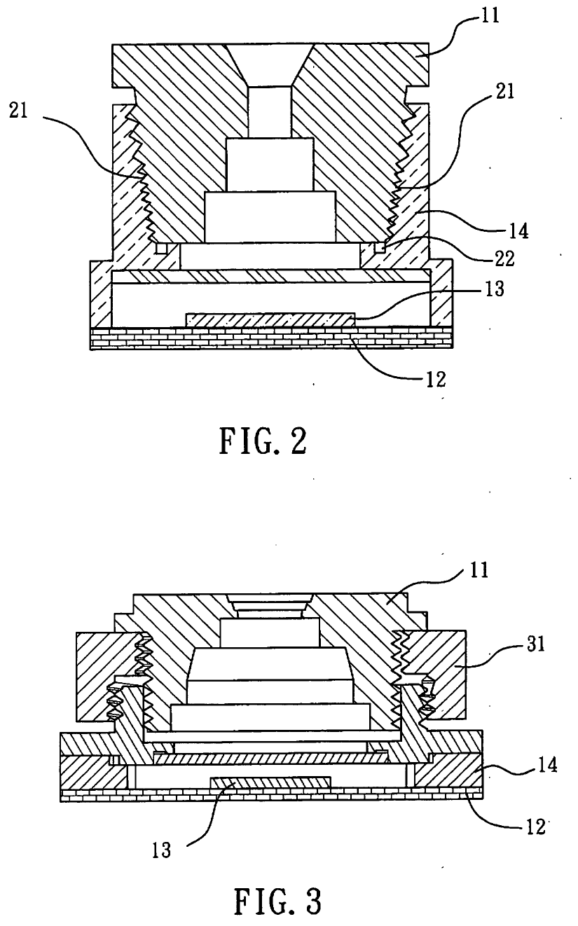

Referring to FIG. 2, the second embodiment of the present invention provides an electrical micro optics module with particle and moisture resistance through tapered thread design with reduced pitch. A typical eMOM contains a substrate 12, an image sensor 13, a lens barrel 11, and a lens mount 14. Tapered thread 21 forces the surfaces of the barrel and the mount to match closer during advancing or tightening. The smaller the clearance between the barrel and the mount, the fewer amounts for particles, moisture or light to pass through the passage. Besides, impact or vibration robustness is improved due to tighter thread coupling and self-lock effect. In the present embodiment, the thread pitch is reduced gradually from outermost side (Object side) to the innermost side (Image side). In the embodiment shown in FIG. 2, a tapered thread 21 with varied pitch is shown. Tapered structure facilitates eccentricity control, too. Reducing pitch enhances the tightening effect abovementioned, in which particle prevention, moisture resistance, opaqueness and vibration isolation improvements are implicated. Additionally, a particle collection groove 22 can be designed to collect the particles further.

Referring to FIG. 3, the third embodiment of the present invention provides an electrical micro optics module with particle and moisture resistance through an outer thread collar 31 design. A typical eMOM contains a substrate 12, an image sensor 13, a lens barrel 11, and a lens mount 14. As can be seen from the drawing, an outer thread collar 31 facilitates the function of threading and particles generated during threading will drop mostly outside the area of light path by the three-part design of lens mount, lens barrel, and outer thread collar. Elongated moisture and light passage can be expected, too.

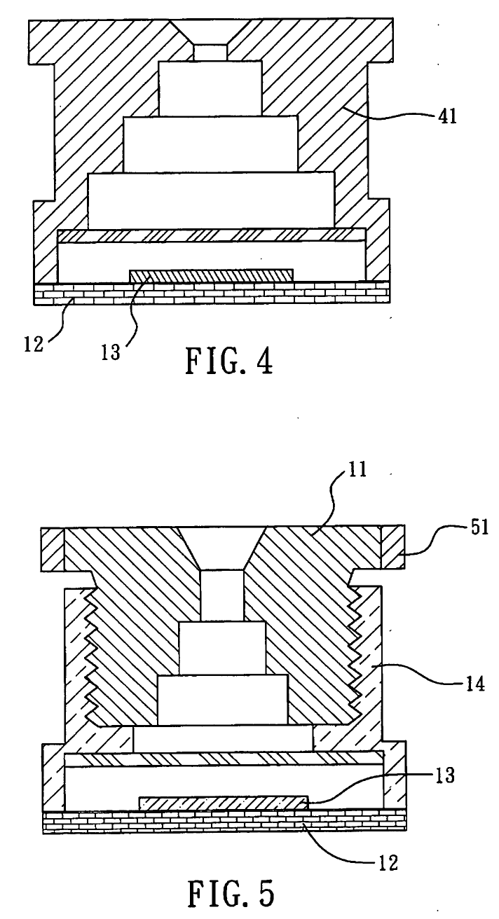

Referring to FIG. 4, the fourth embodiment of the present invention provides an electrical micro optics module with particle and moisture resistance through a compact lens 41 design (One piece). Merging (or combining) the interface between the lens barrel and mount together will reduce the possible particle, moisture and light leakage by reducing their path to only the lens set to substrate surface. In addition, the total module height can thus been reduced further since no extra structure lies between the innermost lens surface and sensor chip surface. Although the focus must be calculated to some accuracy prior to assembly, the present invention provides high throughput, low cost and compact solutions at the expense of image quality. For most lens manufacturers today, the depth of focus for lower resolution optical lens can be easily controlled to be larger than 100 um set as well as the dimensional tolerance of parts can be easily controlled to be less than 10 um, respectively. This indicates that fine focusing adjustment is not required for a low resolution electrical micro-optics module.

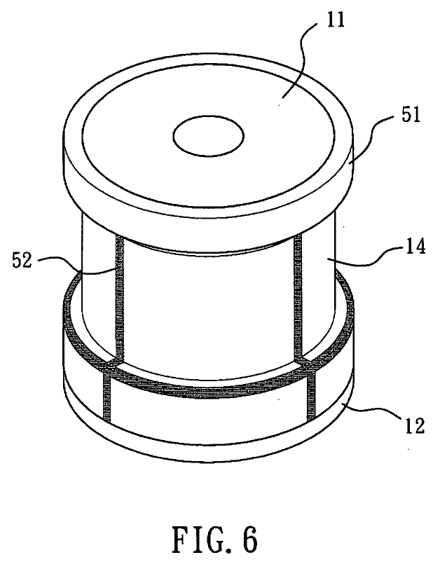

Referring to FIG. 5, the fifth embodiment of the present invention provides an electrical micro optics module with ESD and EMI protection by adding a metal ring 51. A typical eMOM contains a substrate 12, an image sensor 13, a lens barrel 11, and a lens mount 14. The metal ring 51 is located in the plane perpendicular to radius of the lens barrel and the circumference on the barrel is located on the plane. Moreover, conductive paint (not shown in FIG. 5) is used on all outer surfaces, including both outer surfaces of the barrel and the mount, except the lens or the place within the light path. The conductive paint 52 does not need to cover all outer surfaces and only requires painted area forming a conduction path to the substrate and an example thereof is shown in FIG. 6. The space between electrodes of the sensor, however, will be electrically isolated. The protection arises from the conduction path through painting and metal ring to mounting surface of the module.

1. An electrical micro-optic module, comprising:
a substrate;
an image sensor located on the substrate;
a lens barrel in the shape of a cylinder, comprising a first circumferential surface, a first end surface, and a second end surface, wherein a first thread structure is formed on said first circumferential surface and a first zig-zag structure is formed on the second end surface;
a lens mount covering the substrate and comprising a holding structure, where the inner walls thereof are formed in an appropriate shape so as to install said lens barrel therein, and said appropriate shape comprising a second circumferential surface and an third surface, wherein a second thread structure is formed on said second circumferential surface and a second zig-zag structure is formed on the third end surface,
whereby the first thread structure of the first circumferential surface is threaded into the second thread structure of the second circumferential surface, and after threading, the first zig-zag structure on the second end surface contacts and matches with the second zig-zag structure on the third end surface.

2. The module as claimed in claim 1, wherein the zig-zag structures of the second end surface and the third end surface form patterns of concentric circles to maintain contact and matching between the second end surface and the third end surface during threading.

3. The module as claimed in claim 1, further comprising a particle collection groove located on the third end surface to collect and isolate particles generated during threading.

4. The module as claimed in claim 3, wherein the particle collection groove is formed in the pattern of at least one concentric circle.

5. The module as claimed in claim 1, wherein the first circumferential surface of the lens barrel is tilted in a degree smaller than 90 degrees so that the lens barrel tapers off towards the direction of the lens mount, while the second circumferential surface is correspondingly tilted to receive the lens barrel.

6. The module as claimed in claim 1, wherein the first thread structure of the first circumferential surface of the lens barrel and the second thread structure of the second circumferential surface of the lens mount comprise gradually reduced pitch.

7. The module as claimed in claim 6, wherein the pitch reduces towards the tapered end of the lens barrel.

8. The module as claimed in claim 1, further comprising a collar structure located outside both the lens barrel and lens mount to contact both the lens barrel and lens mount on a surface of contact, the thread structures of the first circumferential surface of the lens barrel and the second circumferential surface of the lens mount furthermore being moved to said surface of contact.

9. The module as claimed in claim 1, wherein the first thread structure of the first circumferential surface of the lens barrel and the second thread structure of the second circumferential surface of the lens mount are merged together so that the lens barrel and lens mount are substantially a whole piece.

10. The module as claimed in claim 1, further comprising conductive paint painted on outer surfaces of the lens barrel and lens mount, thereby foiling conduction passages to the substrate to guide electrical charge to the substrate.

11. The module as claimed in claim 10, further comprising a metal part located on an exposed surface of the lens barrel.

12. The module as claimed in claim 8, further comprising conductive paint painted on outer surfaces of the lens barrel and lens mount, thereby forming conduction passages to the substrate to guide electrical charge to the substrate.

13. The module as claimed in claim 12, further comprising a metal part located on exposed surfaces of the lens barrel.

14. The module as claimed in claim 11, wherein the metal part is a ring.

15. The module as claimed in claim 13, wherein the metal part is a ring.
